(19) United States
(12) Patent Application Publication
(10) Pub. No.: US 2015/0339277 A1
(43) Pub. Date: Nov. 26, 2015

(54) SYSTEMS AND METHODS FOR PROGRAMMING BEHAVIOR OF A WEBSITE TO RESPOND TO CAPABILITIES OF DIFFERENT DEVICES

(71) Applicant: Search Optics, LLC, San Diego, CA (US)

(72) Inventor: Luis Alejandro Platt Pou, San Diego, CA (US)

(21) Appl. No.: 14/714,610

(22) Filed: May 18, 2015

Related U.S. Application Data
(60) Provisional application No. 62/002,665, filed on May 23, 2014.

(51) Int. Cl. G06F 17/22; G06F 17/30; H04L 29/08

(52) U.S. Cl. CPC G06F 17/2247; H04L 67/02; G06F 17/30899

(57) ABSTRACT

Methods, systems, means and machine-readable media embodying program instructions for designing, coding and providing a webpage. Certain methods identify desired behaviors of the webpage based on user selections, and then generate code based on the user selections. The generated code is provided to a computing device that requests the webpage. In some embodiments, the user selections of desired behavior, which may differ for different requesting computing devices, are provided by users with no coding experience such that the generation of the code occurs in response to the user selections.

### RELATED APPLICATIONS

The disclosure relates to U.S. Provisional Patent Application No. 62/002,665, filed on May 23, 2014, entitled SYSTEMS AND METHODS FOR PROGRAMMING BEHAVIOR OF A WEBSITE TO RESPOND TO CAPABILITIES OF DIFFERENT DEVICES, the content of which is incorporated by reference herein.

### FIELD

Various embodiments relate to designing, coding and providing a website, and more particularly, to networks, devices, methods and machine-readable media for identifying behaviors of the website based on user selections, generating webpages based on the user selections, and then providing the generated webpages to a computing device that has requested the webpage, where the code controls how content of the website behaves on the requesting computing device.

### BACKGROUND

The World Wide Web (the “Web”) has become an important communications portal for various endeavors, from personal learning to conducting business. To take advantage of the Web, it may be necessary for businesses and individuals to design and maintain multiple websites that people can visit from various computing devices (e.g., personal computers, tablets, mobile phones, and the like). The procedure for designing and building each website has historically taken one of two paths for website operators. One path involves hiring a skilled website developer (or many developers) to work with the website operator to design and build the website. This approach is often costly. Another path involves use of software applications that assist the operator in generating the website, which is a lower cost alternative to hiring a developer, but the look and feel of the resulting website may be limited by choices offered by those software applications. In both cases, a business or an individual must design and build different websites to present the same content to different computing devices. The need to design, build and maintain multiple websites that provide the same content is costly and/or time-consuming, and also adds unneeded complexity when hosting the multiple websites.

New, cost-effective approaches are needed that allow an operator to design and build one website to behave differently on different computing devices without hiring a developer.

### SUMMARY

Certain embodiments of this disclosure relate generally to networks, devices, methods and machine-readable media for setting responsive behaviors of a website for various capabilities of web-enabled computing devices. In some embodiments, such networks, devices, methods and machine-readable media may identify a set of website behavior settings specified by a user via a graphical user interface, where the set of website behavior settings specify different appearances of the website on different screen sizes. The networks, devices, methods and machine-readable media may further generate programming code based on the set of website behavior settings specified by the user, where the programming code specifies the different behaviors of the website when the website appears on the different screen sizes.

### DRAWINGS

FIG. 1A shows an environment within which aspects of the disclosure may operate.

FIG. 1B depicts a network system within which aspects of the disclosure may operate.

FIG. 2 depicts a device system within which aspects of the disclosure may operate.

FIG. 3 illustrates a process for designing, coding and providing websites.

FIG. 4 illustrates a process for designing, coding and providing websites.

FIG. 5 depicts a user interface for setting initial parameters of a website's behavior.

FIG. 6 illustrates a process for setting initial parameters of a website's behavior.

FIG. 7A depicts a user interface for setting a website's behavior.

FIG. 7B depicts a user interface for modifying settings of a website's behavior.

FIG. 8 illustrates a process for modifying settings of a website's behavior.

FIG. 9 illustrates a process for generating a website's code based on selected behaviors of the webpage.

FIG. 10A depicts a first instance of a re-sizable window that illustrates how content will be displayed on a first screen size.

FIG. 10B depicts a second instance of the re-sizable window that illustrates how content will be displayed on a second screen size.

### DETAILED DESCRIPTION

Various embodiments described herein relate to design of a single website that behaves differently on different computing devices. These embodiments provide user-friendly processes for designating the different behaviors of the website without requiring that the user have any coding expertise. Once a user designates the behaviors, processors build webpage(s) based on matching the designated behaviors to coded instructions that, when executed, implement the designated behaviors on the different computing devices.

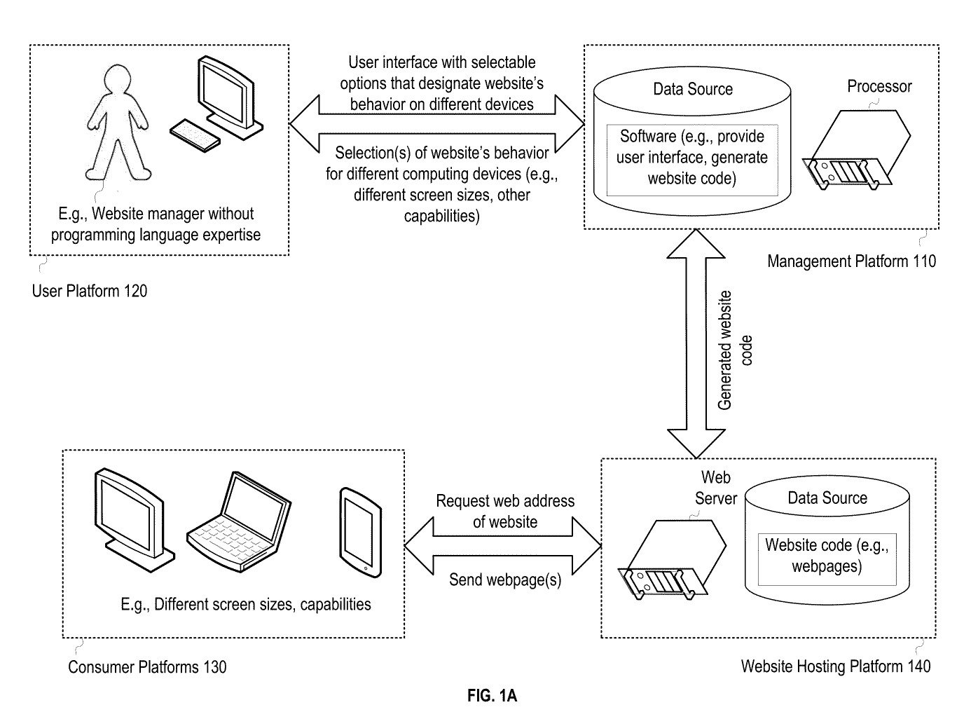

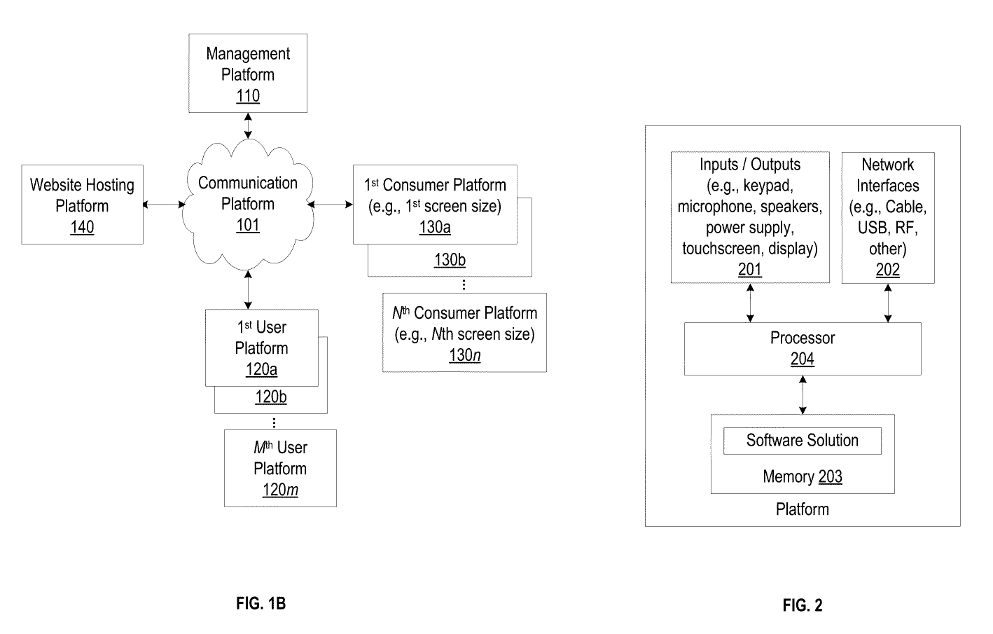

FIG. 1A shows an environment within which responsive behavior of a website is designed, webpages are generated based on the designed behavior, the generated webpages are stored, and the webpages are provided to consumers. The environment includes four “platforms” (described below), including a management platform 110, a user platform 120, consumer platforms 130 and a website hosting platform 140. The four platforms operate in accordance with different aspects disclosed herein. The management platform 110 provides a user interface to the user platform 120, which receives user selections that indicate desired behaviors of a website when presented to consumer platforms 130 with different capabilities. In one embodiment, user selections designate how content appears on different screen sizes.

The user platform 120 transmits the user selections to the management platform 110, which interprets the user selections, and then generates webpages based on the selections. The generated webpages are eventually stored at the website hosting platform 140, which provides the webpages to different consumer platforms 130 upon receiving a request from those different consumer platforms 130 (e.g., via input of a URL at the consumer platforms 130.

Certain platforms may be co-located (e.g., located on the same computing device) or not co-located (e.g., located on different computing devices). For example, the functionality of the management platform 110 may be accessible at the user platform 120 via a cloud-based or network-based service, and/or it may be accessible at the user platform 120 via a local copy that was downloaded to the user platform 120. Thus, in one embodiment, the management platform 110 and the user platform 120 are not co-located, and, in another embodiment, the management platform 110 and the user platform 120 are co-located. Similarly, the website may be hosted at the management platform 110 instead of the website hosting platform 140.

### Example Systems

FIG. 1B depicts a network system within which aspects of the disclosure may operate. As shown, the network includes one or more communication platforms 101, management platforms 110, user platforms 120, consumer platforms 130, and web hosting platforms 140. The term “platform” as used herein may refer to a single component, a device with multiple components, or a grouping of components or devices at the same location or different locations. A platform may include components or devices that may be hosted by parties other than those directly associated with the labeling of each platform. Each platform may include hardware, software, firmware or other components that receive, process, store and send data. Illustrative aspects of the platforms are described in more detail below.

### Communication Platform 101

The communication platform 101 utilizes any known or later-developed communication technologies to facilitate communication among the various other platforms. Examples of communication technologies include any known or later-developed wired and/or wireless communication pathways, protocols and infrastructure.

### Management Platform 110

In general, the management platform 110 (1) generates and provides a user interface, (2) receives inputs from a user who is interacting with the user interface, (3) interprets the inputs to generate coded instructions in any known or later-developed programming language, and (4) transmits the coded instructions to other platforms. In various illustrative embodiments disclosed herein, the inputs specify different behaviors of a website in association with different capabilities of different consumer platforms 130. It is to be understood, however, that the user inputs may relate to behavior of software applications in general, such that the inputs are used to code the software applications, where the code embodies the desired behavior of the software applications.

The management platform 110 may include various components, including those depicted in FIG. 2 which includes input/output interface(s) 201, network interface(s) 202, memory 203, and processor(s) 204, and may further include a software solution such that the processor 204 executes instructions embodied in the software solution to implement methods disclosed herein. Aspects of different software solutions are described elsewhere in relation to various methods. Processing activities (e.g., generating, determining, identifying, interpreting, and other operations of methods disclosed herein) may be performed by the processor(s) 204.

### User Platform 120

In general, the user platform 120 (1) displays a user interface to a user (e.g., a website operator/manager without programming language expertise), (2) receives and processes inputs from the user who is interacting with the user interface, where the inputs specify desired behaviors of a website on different devices, (3) sends the inputs to the management platform 110, and (4) modifies the user interface to reflect the user's inputs. Details of the user interface, in accordance with various embodiments, are described elsewhere herein.

The user platform 120 may include any suitable computing device that allows a user to interact with other platforms or perform tasks at the user platform 120. For example, the user platform 120 may include personal computers, hand-held or laptop devices, mobile phones, tablets, e-readers, and programmable consumer electronics. The user platform 120 may include various components, including those depicted in FIG. 2 which includes input/output interface(s) 201, network interface(s) 202, memory 203, and processor(s) 204, and may further include a software solution such that the processor 204 executes instructions embodied in the software solution to implement methods disclosed herein. Aspects of different software solutions are described elsewhere in relation to various methods. Processing activities (e.g., generating, determining, identifying, interpreting, and other operations of methods disclosed herein) may be performed by the processor(s) 204.

### Consumer Platform 130

In general, the consumer platforms 130 (1) request a webpage (e.g., via input of a URL), (2) receive the webpage, (3) interpret the webpage to determine how content associated with the webpage should display on a screen of that consumer platform 130, and (4) render the content of the webpage according to instructions embodied in the webpage's code.

The consumer platform 130 may include any suitable computing device that allows a consumer to interact with other platforms or perform tasks at the consumer platform 130. For example, the consumer platform 130 may include personal computers, hand-held or laptop devices, mobile phones, tablets, e-readers, and programmable consumer electronics. The consumer platform 130 may include various components, including those depicted in FIG. 2 which includes input/output interface(s) 201, network interface(s) 202, memory 203, and processor(s) 204, and may further include a software solution such that the processor 204 executes instructions embodied in the software solution to implement methods disclosed herein. Aspects of different software solutions are described elsewhere in relation to various methods. Processing activities (e.g., generating, determining, identifying, interpreting, and other operations of methods disclosed herein) may be performed by the processor(s) 204.

### Website Hosting Platform 140

In general, the website hosting platform 140 stores webpages, and provides the webpages to consumer platforms 130 when requested to do so. The website hosting platform 140 includes a web server and a data source at which webpage(s) are hosted.

While not illustrated in FIG. 1B, features of different platforms may be combined into one platform depending on different design choices. Thus, operations described in relation to one platform can be performed by the other platform. It is also noted that operations described in relation to one platform can be performed on separate platforms even if not explicitly illustrated.

The above systems may implement various methods that are described below.

### Example Methodologies

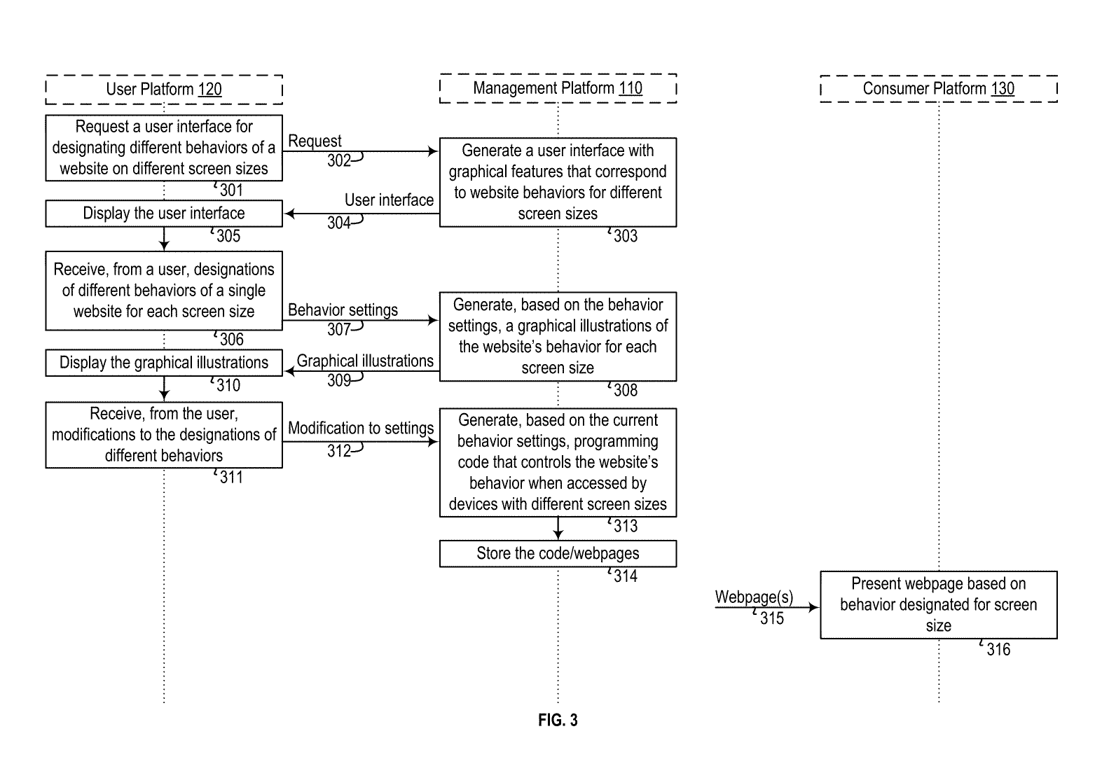

Attention is now drawn to FIG. 3, which illustrates a process for designing, coding and providing webpages in accordance with aspects of the disclosure.

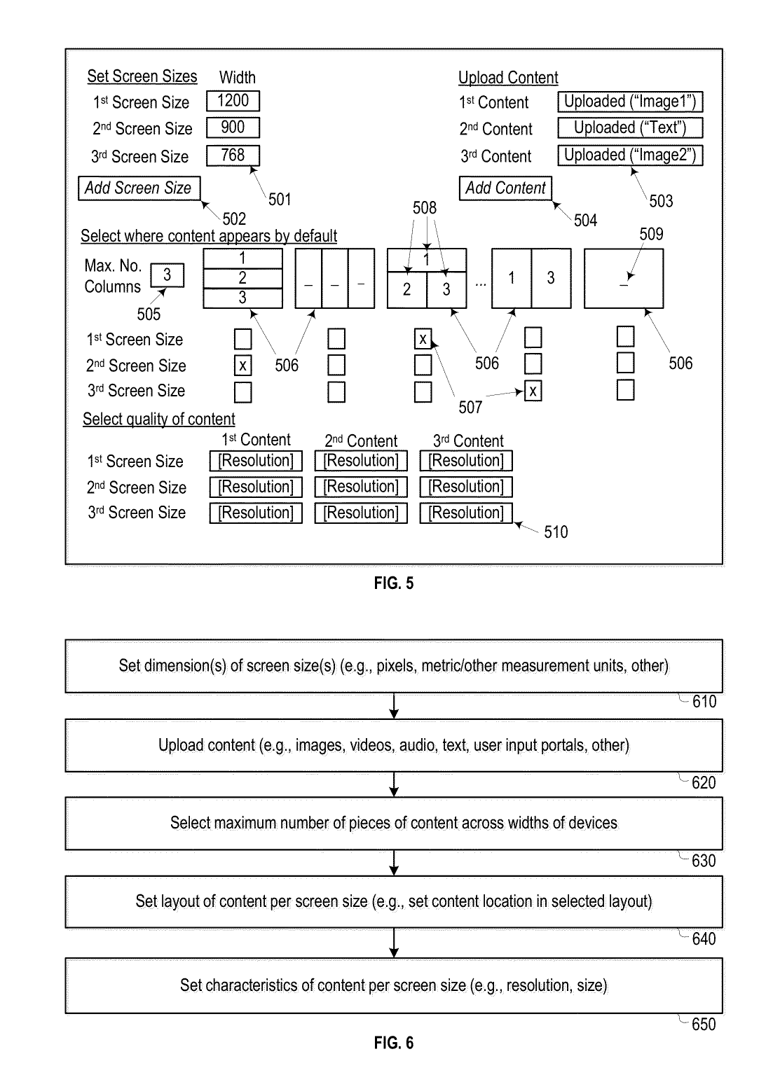

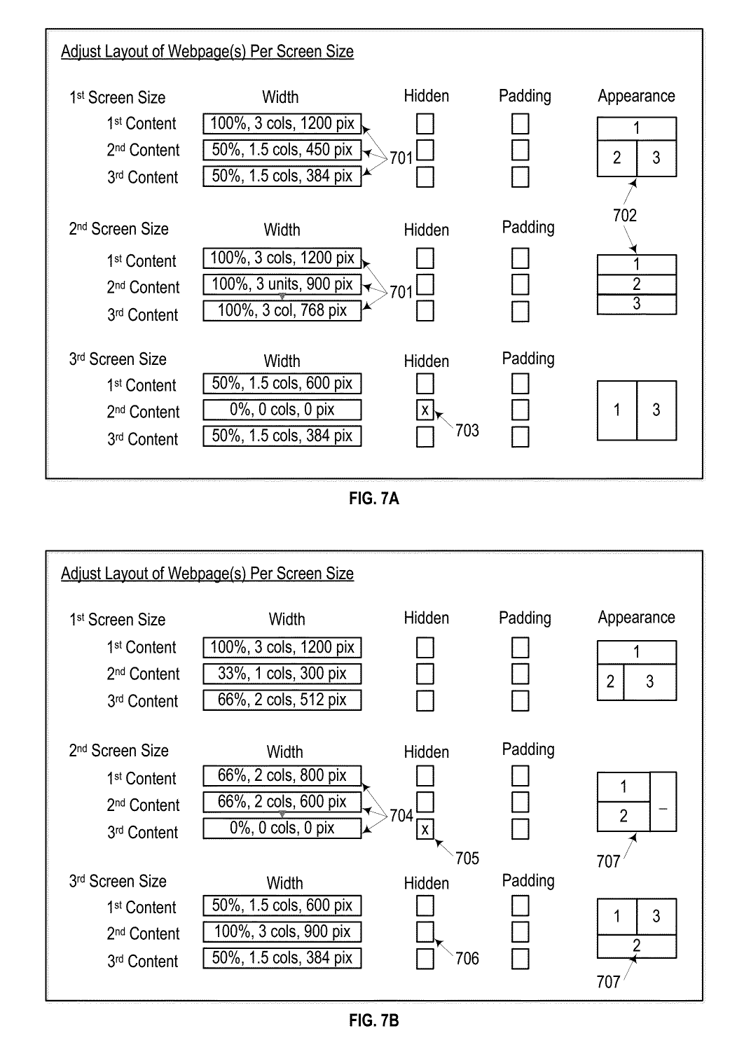

As shown, the user platform 120 generates a request for a user interface that provides a user with options for designating different behaviors of a website based on capabilities of different consumer devices—e.g., designating how content appears on different screen sizes (301). Example user interfaces are described later in relation to FIG. 5, FIG. 7A and FIG. 7B.

The request for the user interface is transmitted to the management platform 110 (302), which generates a user interface with graphical features that correspond to website behaviors for different screen sizes (303), and transmits the user interface (304) to the user platform 120, which displays the user interface to the user (305).

The user platform 120 receives, from the user, inputs that designate different behaviors of the website that correspond to different capabilities of different consumer devices—e.g., designations of how content appears on different screen sizes of the consumer devices (306). These designations may come in the form of user-selected options provided by the user interface. For example, after uploading the content, the user may input, for each screen size (or ranges of screen sizes), a desired size of the content (e.g., relative to other content, or to a dimension of the screen), a desired cropping of the content, a desired quality of the content, a desired placement of the content (e.g., relative to other content, or to the top, left or right border of the screen), whether or when the content will appear, and other desired behaviors of the content.

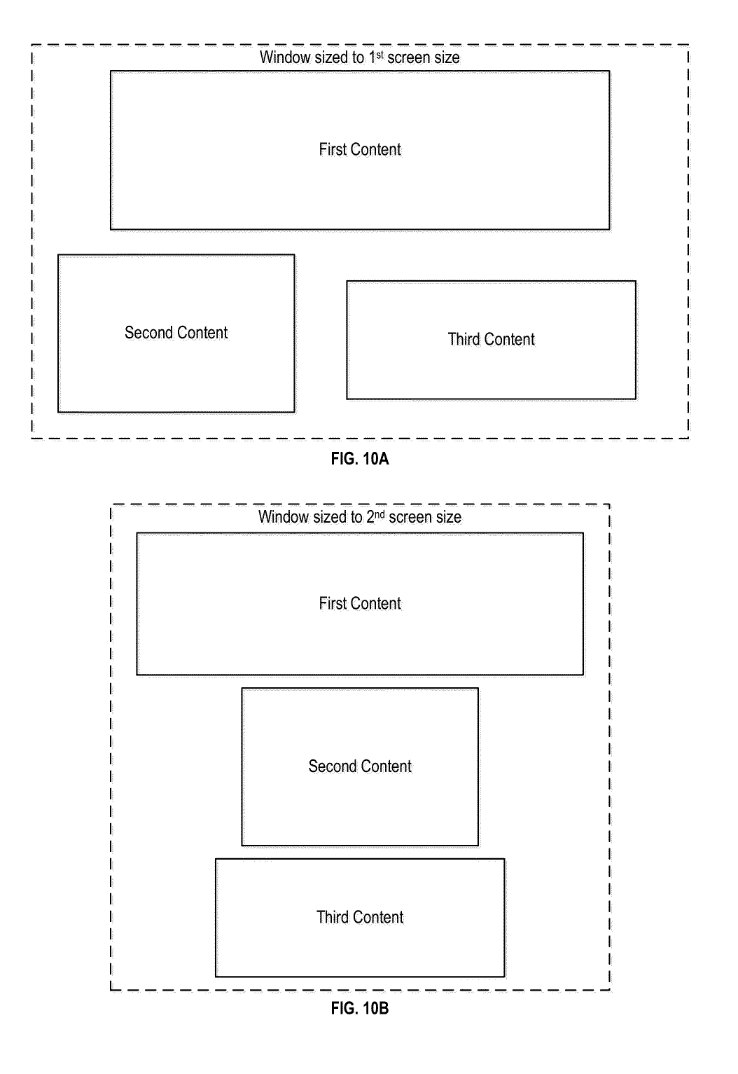

The designated behaviors are transmitted (307) to the management platform 110, which generates graphical illustrations of the designated behavior for each screen size (308), and transmits the graphical illustrations (309) to the user platform 120, which displays the graphical illustrations to a user (310). Examples of graphical illustrations are described in relation to FIG. 7A and FIG. 7B (e.g., see illustrations 702 and 706). Additional examples are provided by FIG. 10A and FIG. 10B, which depict first and second instances of a re-sizable window that illustrates how content will be displayed for first and second screen sizes.

The user platform 120 also receives, if provided from the user, modifications to the behavior designations (311), and then transmits the modifications (312) to the management platform 110. After receiving final behavior settings, the management platform 110 generates programming code that controls the website's behavior when accessed by devices with different capabilities—e.g., different screen sizes (313). The code embodies instructions that are adapted to be executed (e.g., at the consumer devices 130) to implement the designated behaviors responsive to the capabilities of the particular consumer devices 313. Once the code is generated, the code is stored—e.g., as a webpage (314). Once stored, the webpage may be delivered (315) to different consumer platforms 130, each of which present the website in the manner designated for the capability of that content platform 130 (316).

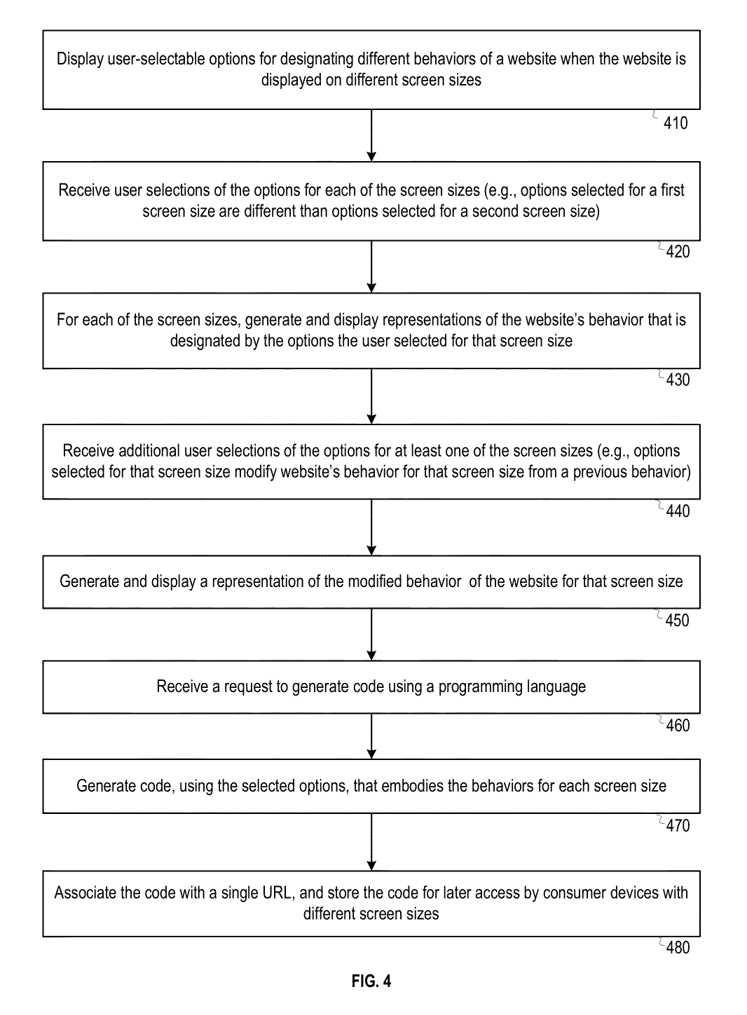

Even though the operations of the process in FIG. 3 are distributed across multiple platforms, it is to be understood that various operations in FIG. 3 can be consolidated to one platform. FIG. 4 illustrates one such implementation, where operations from FIG. 3 are performed by one platform instead of across multiple platforms.

As shown, a platform displays user-selectable options for designating different behaviors of a website when the website is presented on different devices—e.g., different screen sizes (410). Display of the options may occur on a displayed user interface.

The platform receives user selections of the options for each of the devices—e.g., screen sizes (420). In at least one embodiment, options selected for a first screen size are different than options selected for a second screen size. For each of the computing devices, the platform generates and displays representations of the website's behavior that is currently designated by the options the user selected for that device (430). Examples of such representations are described in relation to FIG. 7A and FIG. 7B (e.g., see representations 702 and 706). Additional examples are provided by FIG. 10A and FIG. 10B, which depict first and second instances of a re-sizable window that illustrates how content will be displayed for first and second screen sizes.

The platform may also receive additional user selections of the options for at least one of the devices (440). For example, the options selected for that device modify the website's behavior for that device from a previous behavior. The platform may then generate and display a representation of the modified behavior of the website for that device (450).

Once the user is satisfied with the behavior settings, the platform receives a request to generate code—e.g., where the code is to be generated using a programming language (460). The platform generates webpage code embodying instructions, that when executed by processor(s), implement the behavior settings in association with each device (470). Once generated, the webpage code is stored in association with a URL (480).

Attention is now turned to FIG. 5, which depicts a user interface for setting initial parameters of a website's behavior.

The user interface depicted in FIG. 5 includes user-selectable options for designating screen sizes. By way of example, option 501 for inputting a screen size, and option 502 for adding a new screen size. Screen sizes may be designated by width, by ranges of width, by maximum widths, or by other approaches. The units of width may include numbers of pixels, measured lengths (e.g., metric, US customary, other), and other units known in the art. The width value shown may be exact values, minimum values, median values, maximum values, or other values. The designated widths for each screen size may be compared to each other to determine ranges of widths that fall between the designated widths, and those ranges of widths may then be assigned to one of the identified screen sizes (e.g., the 2^{nd} screen size may include all screen widths between 900 to 1199 pixels). Of course, other screen size parameters may be designated, including height measurements, diagonal measurements, aspect ratios, pixel densities, and other characteristics of a screen.

The user interface depicted in FIG. 5 includes user-selectable options for uploading content. By way of example, option 503 for uploading content, and option 502 for adding new content.

The user interface depicted in FIG. 5 also includes user-selectable options for designating the number of sections, from left to right, within which, or over which, content may be placed. By way of example, option 505 designates three sections across the width of a screen. These sections are often referred to as columns. The width of the sections may be determined by dividing the designated screen sizes by the number of sections. Alternatively, the width of each section may also be set (not shown).

Default layouts (506) are generated, and the user may select particular layouts for particular screen sizes by selecting boxes (507) under the layouts and in line with different screen sizes. By way of example, the left-most layout is selected for the 2^{nd} screen size, the middle layout is selected for the 1^{st} screen size, and the fourth layout from the left-most layout is selected for the 3^{rd} screen size. These layouts indicate relative placement of the 1^{st} content, 2^{nd} content and 3^{rd} content.

Once default layouts are selected, the user designates how content will appear in the selected layout (508). By way of example, the 1^{st} content will display above 2^{nd} content and the 3^{rd} content, and the 2^{nd} content and the third content will display side-by-side, on the 1^{st} screen size. No designations (509) are made by the user for unselected layouts.

The user may also designate the content's resolution for each screen size (510). Of course, other characteristics of the content may be designated, including size, compression, cropping, and other characteristics.

FIG. 6 illustrates a process for setting the initial parameters of the website's behavior in accordance with aspects of the disclosure. As shown, dimension(s) of screen size(s) are determined (610), and content is uploaded (620). Various types of content are contemplated, as would be known or developed later in the art—e.g., images, videos, audio, text, user input portals, other content).

A maximum number of pieces of content across widths of devices may a designated (630). In FIG. 5, the maximum number is three (3). Layouts that comply with the maximum number of pieces of content are provided, and some of those layouts are selected for different screen size. The position of the uploaded content is designated for each selected layout (640). Finally, characteristics of content are designated per screen size (650).

Once initial parameters of a website's behavior are set, user interfaces may be provided that allow a user to designate and modify the website's behaviors for different devices. Such user interfaces are illustrated in FIG. 7A and FIG. 7B.

FIG. 7A depicts a user interface for setting a website's behavior. The user interface depicted in FIG. 7A includes user-selectable options for setting widths of particular content or content containers within which the content is placed (e.g., actual, minimum or maximum widths of the content or content containers), or for designating whether the content will share any of the screen's width with other content. By way of example, options 701 for the 2^{nd} screen size may designate that each of the 1^{5t} content, 2^{nd} content and 3^{rd} content, or respective content containers, will have widths that cover the designated width. Alternatively, options 701 for the 2^{nd} screen size may designate that each of the 1^{st} content, 2^{nd} content and 3^{rd} content, or respective content containers, will not share any of the screen's width with each other (i.e., no portion of one content will be placed to the left or the right of other content along the same row). In this way, the actual width of the content or a content container can be independently set, and need not cover the entire width of a screen.

By way of another example, options 701 for the 1^{st} screen size designate that the 1st content will not share any of the screen's width with other content, and that the 2^{nd} content and the 3^{rd} content will share the screen's width with each other. Designation of the widths may be accomplished by user settings of a number of pixels, a number of sections/columns, a percentage of the screen's width, or other designations (e.g., a designation that particular content will not share any of the screen's width with other content).

The user interface depicted in FIG. 7A includes a graphical illustration (702) of how the 1^{st} content, 2^{nd} content and the 3^{rd} content will appear relative to each other based on options 701. It is noted that the boxes of the graphical illustration (702) designated as 1, 2 and 3 may illustrate different things. In one embodiment, the boxes represent how the 1^{st}, 2^{nd} and 3^{rd} content are generally positioned relative to each other, such that the relative sizes of the 1^{st}, 2^{nd} and 3^{rd} content and the spacing between the 1^{st}, 2^{nd} and 3^{rd} content are not depicted by the graphical illustration (702). In another embodiment, the boxes illustrate sizes (e.g., widths and/or heights) of content containers, within which the 1^{st}, 2^{nd} and 3^{rd} content may be placed (even if any of the 1^{st}, 2^{nd} and 3^{rd} content are smaller than the designated containers). In another embodiment, the boxes illustrate the actual size (e.g., widths and/or heights) of the 1^{st}, 2^{nd} and 3^{rd} content.

The user interface depicted in FIG. 7A also includes user-selectable options for hiding content. By way of example, selected option 703 causes the 2^{nd} content to not be displayed on the 3^{rd} screen size.

The settings illustrated in FIG. 7A can be modified, as illustrated in FIG. 7B, which depicts a user interface for modifying settings of a website's behavior. The user interface depicted in FIG. 7B includes user-selectable options (704, 705, 706) for changing the settings from FIG. 7A, and further includes graphical illustrations (707) showing of how the 1st content, 2^{nd} content and the 3^{rd} content will appear relative to each other based on the changes to the settings as inputted by the user.

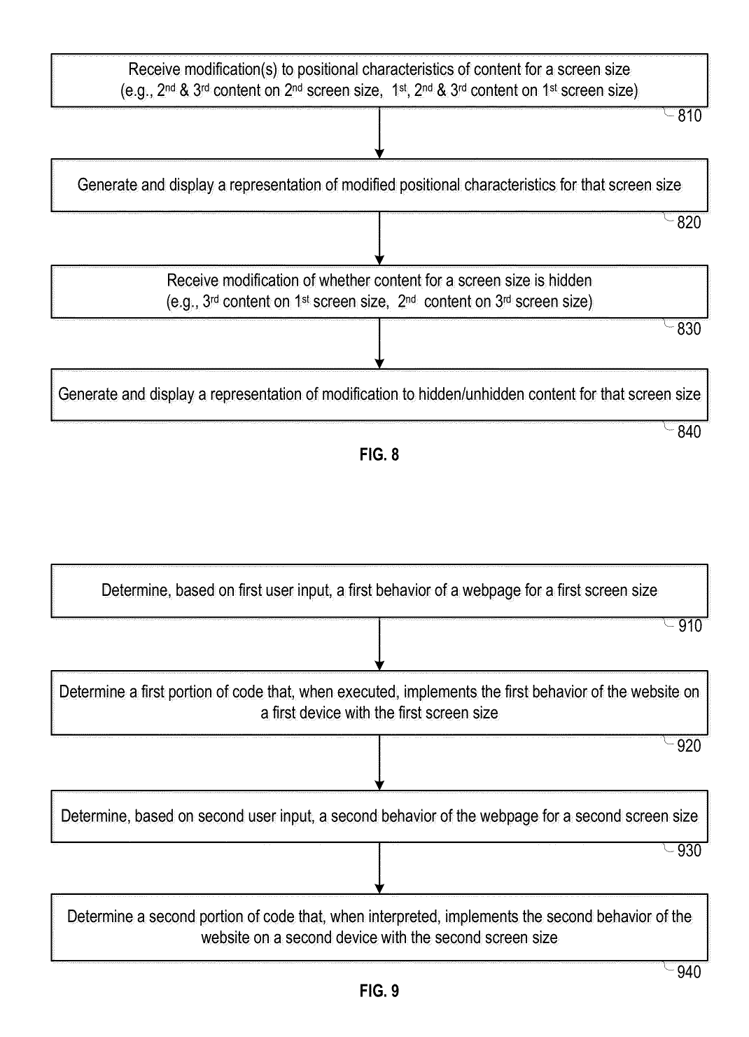

FIG. 8 illustrates a process for modifying settings of a website's behavior. The process may be carried out by one or more of the platforms. As shown, modification(s) to positional characteristics of content for a screen size are received (810). The positional characteristics may be an actual, minimum or maximum width of the content, or a designation that no part of the content will be positioned next to other content across the width of the screen when displayed. A representation of modified positional characteristics is shown (820). Modifications to whether content for a screen size is hidden are received (830). Example modifications to settings from FIG. 7A are shown in FIG. 7B, which illustrates modifications to 3^{rd} content on 2^{nd} screen size (option 705), and modifications to 2^{nd} content on 3^{rd} screen size (option 706). A representation of the modification to hidden/unhidden content for that screen size is shown (840).

Once behavior settings are finalized, webpage code may be generated to include instructions designating the behavior settings. FIG. 9 illustrates a process for generating the code based on selected behaviors of the website. The process may be carried out by one or more of the platforms. As shown, a first behavior of a website for a first device is determined based on first user input—e.g., the user selections from the user interfaces in FIG. 5, FIG. 7A and FIG. 7B (910). After detecting the first user input, the platform determines a first portion of code that, when executed, implements the first behavior of the website on the first device. For example, the first behavior may be implemented by a Web browser on the first device based on instructions embodied in the first portion of the code (920).

In some embodiments, the code may be determined as follows. In general, the user selections are identified (e.g., a maximum number of sections/columns, how “wide” each column or content/content container should be for each given screen size, and other input as previously described). HTML code (or other suitable code) is identified based on the user selections.

One embodiment is described below as an example. One of skill in the art will appreciate alternative embodiments that are within the scope and spirit of this disclosure. For example, the user can specify four screen sizes: (1) >=1200 pixels; (2) >=992 pixels; (3) >=768 pixels; and (4)<768 pixels. These screen sizes translate to CSS classes: (1) col-lg; (2) col-md; (3) col-sm; and (4) col-xs on the generated HTML code. The maximum number of columns may be input by the user as 2, and the width of each column (or content/container) may be specified as a number of the maximum number of columns (e.g., 1, 2, ½, and the like). For example, if side-by side content is desired for the two larger screen sizes (e.g., sizes (1) and (2) above), and vertically stacked content is desired for the two smaller screen sizes (e.g., sizes (3) and (4) above), then the following code could be generated: <div><div class=“col col-lg-1 col-md-1 col-sm-2 col-xs-2”></div><div class=“col col-lg-1 col-md-1 col-sm-2 col-xs-2”></div></div>. The “1” designates one of the two maximum columns are allotted per content, and the “2” designates all of the two maximum columns are allotted per content. Thus, predefined code may be used, where that code has definable parameters that are defined by the user-specified behaviors (e.g., the number of columns over which content will display). In the example above, the predefined code includes, among other parts, col-lg-x, col-md-x, col-sm-x, and col-xs-x, where x is a definable parameter that is defined as 1, 1, 2 and 2, respectively.

The screen sizes may be predefined and prepopulated instead of allowing the user to set those screen sizes. The user may then be left with identifying the size (e.g., width) of content or content containers for each predefined size.

It is further noted that the widths of content/content containers may be restricted to whole numbers of columns (e.g., 1 to 12, or none), not fractional numbers (½ and the like). However, this is viewed as a design choice.

The same process may be followed for other user inputs that designate other behavior for other devices. For example, operations 930 and 940 are illustrated for second user input relating to a second behavior in association with a second device.

Prior to or after generating code, the user may want to view how uploaded content will behave for different users on different devices. Additional processes are contemplated that provide for a re-sizable window that illustrates how content will be displayed on different screen sizes.

FIG. 10A depicts a first instance of the re-sizable window that illustrates how content will be displayed on a first screen size. After the user has sized the window (e.g., by clicking and dragging a corner or side of the window across a screen of a platform), the platform may determine the size of the window, and then identify (e.g., look up) the layout of the website for a screen size that matches the size of the window. By way of example, the platform may match the width of the window to a width of a screen size, or a range of widths associated with a screen size. The platform may then display the content based on the layout that was identified. By way of example, the placement of actual content based on the layout for the 1^{st} screen size from FIG. 7A is depicted in FIG. 10A.

FIG. 10B depicts a second instance of the re-sizable window that illustrates how content will be displayed on a second screen size in accordance with aspects of the disclosure. After the user has resized the window, the platform may determine the new size of the window, and then identify (e.g., look up) a new layout of the website for a screen size that matches the new size of the window. By way of example, the platform may match the new width of the window to a width of a screen size, or a range of widths associated with a screen size. The platform may then display the content based on the new layout that was identified. By way of example, the placement of actual content based on the layout for the 2^{nd} screen size from FIG. 7A is depicted in FIG. 10B. The sizes of the content may be increased or reduced automatically to fit the new screen size (e.g., as is the case for the First Content).

Having a resizable window, as illustrated in FIG. 10A and FIG. 10B, permits a user to quickly view how content will appear on multiple screens so that the user can make adjustments. Additional features of the resizable window, while not illustrated, permit the user to select particular content in the resizable window, and then resize it or move it, which changes the behavior settings displayed on the user interfaces of FIG. 5, FIG. 7A and FIG. 7B.

### Other Aspects Related to Systems & Methods

Functionality and operation disclosed herein may be embodied as one or more methods implemented by machine(s)—e.g., processor(s)—at one or more locations. Non-transitory machine-readable media embodying program instructions adapted to be executed to implement the method(s) are also contemplated. Execution of the program instructions by one or more processors cause the processors to carry out the method(s).

By way of example, not by way of limitation, method(s) may comprise: identifying a first set of website behavior settings specified by a user via a graphical user interface, wherein the first set of website behavior settings specify different behaviors of the website on different screen sizes; and generating programming code based on the first set of website behavior settings specified by the user, wherein the programming code specifies the different behaviors of the website on the different screen sizes.

In accordance with some aspects, the first set of website behavior settings are based on selections, by the user, of different website behaviors displayed on the graphical user interface.

Method(s) may further or alternatively comprise: causing graphical representations of the website behavior settings to display to the user via the graphical user interface, wherein the first set of website behavior settings are based on selections, by the user, of the graphical representations.

In accordance with some aspects, the first set of website behavior settings are specified by the user in a form other than a website programming language.

In accordance with some aspects, the website behavior settings specify a first behavior of the website when the website outputs on a first device with a first screen size, wherein the website behavior settings specify a second behavior of the website when the website outputs on a second device with a second screen size, and wherein the first behavior and the second behavior are different.

In accordance with some aspects, the website behavior settings specify a first appearance of the website's content on a first screen size, and wherein the website behavior settings specify a second appearance of the website's content on a second screen size.

In accordance with some aspects, the website behavior settings specify a first size of first content of the website for a first screen size, and wherein the website behavior settings specify a second size of the first content for a second screen size.

In accordance with some aspects, the website behavior settings specify that a first size of first content relative to a feature of the website is different for a first screen size than a second size of the first content relative to the feature of website for a second screen size.

In accordance with some aspects, the feature of the website is a size of second content.

In accordance with some aspects, the website behavior settings specify that a first size of first content relative to a dimensional parameter of a first screen size is different than a second size of the first content relative to the dimensional parameter of a second screen size.

In accordance with some aspects, the dimensional parameter is a width or a height of the respective screen.

In accordance with some aspects, the website behavior settings specify a first location of first content of the website for a first screen size, and wherein the website behavior settings specify a second location of the first content for a second screen size.

In accordance with some aspects, the website behavior settings specify that a location of first content relative to a feature of the website is different for a first screen size than a second screen size.

In accordance with some aspects, the feature of the website is the top of the website.

In accordance with some aspects, the feature of the website is a location of other content of the website.

In accordance with some aspects, the website behavior settings specify that first content of the website and second content of the website are positioned along a vertical screen axis when displayed on a first screen size and are positioned along a horizontal screen axis when displayed on a screen size.

In accordance with some aspects, the website behavior settings specify that first content of the website displays on a first screen size, but does not display on a second screen size.

Method(s) may further or alternatively comprise: causing the graphical user interface to display a graphical representation, for each of the different screen sizes, that shows sizes of content or content containers relative to each other.

In accordance with some aspects, a first graphical representation associated with a first screen size indicates a first set of relative sizes of first content and second content, wherein a second graphical representation associated with a second screen size indicates a second set of relative sizes of the first content and the second content, and wherein the first set of relative sizes is different than the second set of relative sizes.

Method(s) may further or alternatively comprise: causing the graphical user interface to display a graphical representation, for each of the different screen sizes, that shows locations of content or content containers relative to each other.

In accordance with some aspects, a first graphical representation associated with a first screen size indicates a first set of relative locations of first content and second content, wherein a second graphical representation associated with a second screen size indicates a second set of relative locations of the first content and the second content, and wherein the first set of relative locations is different than the second set of relative locations.

Method(s) may further or alternatively comprise: causing the graphical user interface to display a graphical representation, for each of the different screen sizes, that shows whether or not each content or content container of the website will display on that screen size.

In accordance with some aspects, a first graphical representation associated with a first screen size indicates that first content will display when the website is delivered to a device with the first screen size, and wherein a second graphical representation associated with a second screen size indicates that the second content will not display when the website is delivered to a device with the second screen size.

Method(s) may further or alternatively comprise: receiving, at a first instance in time, data that specifies a first screen size of a display window on a computing device of the user; analyzing the first set of website behavior settings to determine a first behavior of the website that is associated with the first screen size; and causing the website to display in the display window in a manner defined by the first behavior.

Method(s) may further or alternatively comprise: receiving, at a second instance in time, data that specifies a second screen size of the display window; analyzing the first set of website behavior settings to determine a second behavior of the website that is associated with the second screen size; and causing the website to display in the display window in a manner defined by the second behavior.

Method(s) may further or alternatively comprise: causing graphical representations of the website behavior settings to display to a user via a graphical user interface, wherein the first set of website behavior settings are based on selections, by the user, of the graphical representations, and wherein the website behavior settings specify a first way of displaying the website's content on a first screen size, and a second way of displaying the website's content on a second screen size, wherein the first way of displaying the website's content is different than the second way of displaying the website's content.

Method(s) may further or alternatively comprise: generating, for each of the different screen sizes, data relating to sizes or locations of content or content containers.

Method(s) may further or alternatively comprise: receiving, at a first instance of time, data specifying that a size of a display window on a computing device is the first screen size; identifying the first way of displaying the website's content based on the data specifying that the size of the display window is the first screen size; causing the website to display in the display window in a manner defined by the first way of displaying the website's content; receiving, at a second instance of time, data specifying that the size of the display window is the second screen size; identifying the second way of displaying the website's content based on the data specifying that the size of the display window is the second screen size; and causing the website to display in the display window in a manner defined by the second way of displaying the website's content.

In accordance with some aspects, the first way of displaying the website's content specifies a first relative size of first content with respect to second the content, wherein the second way of displaying the website's content specifies a second relative size of the first content with respect to the second the content, and wherein the first relative size is different than the second relative size.

In accordance with some aspects, the first way of displaying the website's content specifies a first relative location of first content with respect to second the content, wherein the second way of displaying the website's content specifies a second relative location of the first content with respect to the second the content, and wherein the first relative location is different than the second relative location.

Any portion of the functionality embodied in the method(s) above may be combined with any other portion of that functionality.

Outputs from a first device or group of devices may be received and used by another device during performance of methods. Accordingly, an output from one device may cause another device to perform a method even if intervening steps occur between the output and performance of the method where performance of the method is based on the output.

The illustrative systems, methods, logical features, blocks, modules, components, circuits, and algorithm steps described herein may be implemented, performed, or otherwise controlled by suitable hardware known or later-developed in the art, or by firmware or software executed by processor(s), or any combination of hardware, software and firmware.

Methods described herein as being performed by multiple platforms, devices or components can be performed by a single platform, device or component, and methods described herein as being performed by a single platform, device or component can be performed by multiple platforms, devices or components. In some embodiments, software solutions are used by the platform(s), device(s) or component(s) to carry out the methods. Such software solutions may be downloadable and non-downloadable.

Systems may include one or more devices or means that implement the functionality (e.g., embodied as methods) described herein. For example, such devices or means may include processor(s) that, when executing instructions, perform a portion or all of any method disclosed herein. Such instructions can be embodied in software, firmware and/or hardware. A processor (also referred to as a “processing device”) may perform or otherwise carry out any of the operational steps, processing steps, computational steps, method steps, or other functionality disclosed herein, including analysis, manipulation, conversion or creation of data, or other operations on data. A processor may include, or be included within, a general purpose processor, a digital signal processor (DSP), an integrated circuit, a server, other programmable logic device, or any combination thereof. A processor may be a conventional processor, microprocessor, controller, microcontroller, or state machine. A processor can also refer to a chip or part of a chip (e.g., semiconductor chip). The term “processor” may refer to one, two or more processors of the same or different types. It is noted that a computer, computing device and user device, and the like, may refer to devices that include a processor, or may be equivalent to the processor itself.

“Memory” may be accessible by a machine, such that the machine can read information from and/or write information to the memory. It is noted that a “machine” may include a computer, a processor, a controller, or other suitable device as known or later-developed in the art. Memory may be integral with or separate from the machine. Instructions may reside in such memory (e.g., RAM, flash, ROM, EPROM, EEPROM, registers, disk storage), or any other form of storage medium. Memory may include a non-transitory machine-readable medium having machine-readable program code (e.g., instructions) embodied therein that is adapted to be executed to implement any number of the various methods, or variations of such methods, disclosed herein. Machine-readable media may be any available storage media, including non-volatile media (e.g., optical, magnetic, semiconductor). Machine-readable media may be any available storage media, including removable, non-removable, volatile, non-volatile media. Examples of machine-readable media include an electric circuit, a semiconductor storage media (e.g., a semiconductor memory device), a ROM, a flash memory, an erasable ROM (EROM), a floppy diskette or other magnetic storage, a CD-ROM/DVD or other optical storage, a hard disk, or any other medium which can be used to store the desired information and which can be accessed. Carrier waves may be used to transfer data and instructions through electronic, optical, air, electromagnetic, RF, or other signaling media over a network using network transfer protocols. Instructions embodied in software can be downloaded to reside on and operated from different platforms used by known operating systems. Instructions embodied in firmware can be contained in an integrated circuit or other suitable device

Functionality disclosed herein may be programmed into any of a variety of circuitry that is suitable for such purpose as understood by one of skill in the art. For example, functionality may be embodied in processors having software-based circuit emulation, discrete logic, custom devices, neural logic, quantum devices, PLDs, FPGA, PAL, ASIC, MOSFET, CMOS, ECL, polymer technologies, mixed analog and digital, and hybrids thereof. Data, instructions, commands, information, signals, bits, symbols, and chips disclosed herein may be represented by voltages, currents, electromagnetic waves, magnetic fields or particles, optical fields or particles, or any combination thereof. Computing networks may be used to carry out functionality and may include hardware components (servers, monitors, I/O, network connection). Application programs may carry out aspects by receiving, converting, processing, storing, retrieving, transferring and/or exporting data, which may be stored in a hierarchical, network, relational, non-relational, object-oriented, or other data source.

All of the information disclosed herein may be represented by data, and that data may be transmitted over any communication pathway using any protocol, stored on any data source, and processed by any processor. For example, transmission of data may be carried out using a variety of wires, cables, radio signals and infrared light beams, and an even greater variety of connectors, plugs and protocols even if not shown or explicitly described. A data source may be a single storage device or realized by multiple (e.g., distributed) storage devices. A data source may include one or more types of data sources, including hierarchical, network, relational, non-relational, object-oriented, or another type of data source. As used herein, machine-readable media includes all forms of machine-readable medium except, to the extent that such media is deemed to be non-statutory (e.g., transitory propagating signals).

Features in system and apparatus figures that are illustrated as rectangles may refer to hardware, firmware or software. It is noted that lines linking two such features may be illustrative of data transfer between those features. Such transfer may occur directly between those features or through intermediate features even if not illustrated. Where no line connects two features, transfer of data between those features is contemplated unless otherwise stated. Accordingly, the lines are provided to illustrate certain aspects, but should not be interpreted as limiting. The words “comprise,” “comprising,” “include,” “including” and the like are to be construed in an inclusive sense (i.e., not limited to) as opposed to an exclusive sense (i.e., consisting only of). Words using the singular or plural number also include the plural or singular number respectively. The words “or” or “and” cover both any of the items and all of the items in a list. “Some” and “any” and “at least one” refers to one or more. The term “device” may comprise one or more components (e.g., a processor, a memory, a receiver, a screen, and others). The disclosure is not intended to be limited to the aspects shown herein but is to be accorded the widest scope understood by a skilled artisan, including equivalent systems and methods.

1. A method for setting responsive behaviors of a website for various screen sizes of web-enabled computing devices, the method comprising:
identifying a first set of website behavior settings specified by a user via a graphical user interface,
wherein the first set of website behavior settings specify different behaviors of the website on different screen sizes; and
generating programming code based on the first set of website behavior settings specified by the user,
wherein the programming code specifies the different behaviors of the website on the different screen sizes.

2. The method of claim 1, wherein the first set of website behavior settings are based on selections, by the user, of different website behaviors displayed on the graphical user interface.

3. The method of claim 1, wherein the method comprises:
causing graphical representations of the website behavior settings to display to the user via the graphical user interface,
wherein the first set of website behavior settings are based on selections, by the user, of the graphical representations.

4. The method of claim 1, wherein the first set of website behavior settings are specified by the user in a form other than a website programming language.

5. The method of claim 1, wherein the website behavior settings specify a first behavior of the website when the website outputs on a first device with a first screen size, wherein the website behavior settings specify a second behavior of the website when the website outputs on a second device with a second screen size, and wherein the first behavior and the second behavior are different.

6. The method of claim 1, wherein the website behavior settings specify a first appearance of the website's content on a first screen size, and wherein the website behavior settings specify a second appearance of the website's content on a second screen size.

7. The method of claim 1, wherein the website behavior settings specify a first size of first content of the website for a first screen size, and wherein the website behavior settings specify a second size of the first content for a second screen size.

8. The method of claim 1, wherein the website behavior settings specify that a first size of first content relative to a feature of the website is different for a first screen size than a second size of the first content relative to the feature of website for a second screen size.

9. The method of claim 8, wherein the feature of the website is a size of second content.

10. The method of claim 1, wherein the website behavior settings specify that a first size of first content relative to a dimensional parameter of a first screen size is different than a second size of the first content relative to the dimensional parameter of a second screen size.

11. The method of claim 10, wherein the dimensional parameter is a width or a height of the respective screen.

12. The method of claim 1, wherein the website behavior settings specify a first location of first content of the website for a first screen size, and wherein the website behavior settings specify a second location of the first content for a second screen size.

13. The method of claim 1, wherein the website behavior settings specify that a location of first content relative to a feature of the website is different for a first screen size than a second screen size, wherein the feature of the website is the top of the website, or wherein the feature of the website is a location of other content of the website.

14. The method of claim 1, wherein the website behavior settings specify that first content of the website and second content of the website are positioned along a vertical screen axis when displayed on a first screen size and are positioned along a horizontal screen axis when displayed on a screen size.

15. The method of claim 1, wherein the website behavior settings specify that first content of the website displays on a first screen size, but does not display on a second screen size.

16. The method of claim 1, wherein the method comprises:
causing the graphical user interface to display a graphical representation, for each of the different screen sizes, that shows sizes of content relative to each other.

17. The method of claim 1, wherein the method comprises:
causing the graphical user interface to display a graphical representation, for each of the different screen sizes, that shows locations of content relative to each other, wherein a first graphical representation associated with a first screen size indicates a first set of relative locations of first content and second content, wherein a second graphical representation associated with a second screen size indicates a second set of relative locations of the first content and the second content, and wherein the first set of relative locations is different than the second set of relative locations.

18. The method of claim 1, wherein the method comprises:
causing the graphical user interface to display a graphical representation, for each of the different screen sizes, that shows whether or not each content of the website will display on that screen size, wherein a first graphical representation associated with a first screen size indicates that first content will display when the website is delivered to a device with the first screen size, and wherein a second graphical representation associated with a second screen size indicates that the second content will not display when the website is delivered to a device with the second screen size.

19. The method of claim 1, wherein the method comprises:
receiving, at a first instance in time, data that specifies a first screen size of a display window on a computing device of the user;
analyzing the first set of website behavior settings to determine a first behavior of the website that is associated with the first screen size; and
causing the website to display in the display window in a manner defined by the first behavior;
receiving, at a second instance in time, data that specifies a second screen size of the display window;
analyzing the first set of website behavior settings to determine a second behavior of the website that is associated with the second screen size; and
causing the website to display in the display window in a manner defined by the second behavior.

20. The method of claim 1, wherein the method comprises:
causing graphical representations of the website behavior settings to display to a user via a graphical user interface,
wherein the first set of website behavior settings are based on selections, by the user, of the graphical representations, and
wherein the website behavior settings specify a first way of displaying the website's content on a first screen size, and a second way of displaying the website's content on a second screen size, wherein the first way of displaying the website's content is different than the second way of displaying the website's content;
generating, for each of the different screen sizes, data relating to sizes or locations of content;
receiving, at a first instance of time, data specifying that a size of a display window on a computing device is the first screen size;
identifying the first way of displaying the website's content based on the data specifying that the size of the display window is the first screen size;
causing the website to display in the display window in a manner defined by the first way of displaying the website's content;
receiving, at a second instance of time, data specifying that the size of the display window is the second screen size;
identifying the second way of displaying the website's content based on the data specifying that the size of the display window is the second screen size; and
causing the website to display in the display window in a manner defined by the second way of displaying the website's content.
